(19) United States
(12) Patent Application Publication
(10) Pub. No.: US 2019/0319553 A1
(43) Pub. Date: Oct. 17, 2019

(54) THREE-DIMENSIONAL KINETIC GENERATOR

(71) Applicants: Ordonez Marc, El Paso, TX (US); Texas Tech University System, Lubbock, TX (US)

(72) Inventor: Ordonez Marc, El Paso, TX (US)

(21) Appl. No.: 16/335,941

(22) PCT Filed: Sep. 22, 2017
(86) PCT No.: PCT/IB2017/055784

§ 371 Date: Mar. 22, 2019

Related U.S. Application Data
(60) Provisional application No. 62/506,350, filed on May 15, 2017.
(60) Provisional application No. 62/398,048, filed on Sep. 22, 2016.

(51) Int. Cl. H02N 11/00; F03G 7/08

(52) U.S. Cl. CPC H02N 11/002; F03G 7/08

(57) ABSTRACT

A method, system, and apparatus for generating electricity comprises a gyroscope with a core wrapped in coils inside the central void of the gyroscope. One or more rings with a plurality of gears attached thereto can: be connected such that the gyroscope drives the gears. Two magnets are further connected to the gyroscope such that the core wrapped in coils is within the magnetic field between the two magnets, wherein movement of the spheres in relation to the magnets induces an electric current in the coils and an electrical lead provides an output for electric current in the coils.

### FIELD OF THE INVENTION

Embodiments are generally related to the field of generators and more specifically mobile generators. Embodiments are also related to the field device chargers. Embodiments are further related to the field of gyroscopes. Embodiments are also related to the field of three-dimensional kinetic generators. Embodiments are also related to the field of three-dimensional motors/generators. Embodiments are further related to socket stepper motors.

### BACKGROUND

In today's society, almost everyone has a mobile phone, or other electronic device, on his or her person at all times. Mobile devices have become ubiquitous and are central to people's everyday lives. Such devices are necessary to function in modern society. One consequence of the universal use of portable devices is that they run on batteries, which often quickly run out of energy. This is a nuisance because recharging mobile/portable devices can be inconvenient and time consuming.

Users commonly go out of their way to find an energy source to recharge their devices. Alternatively, users are forced to carry heavy and inconvenient batteries for mobile recharging. However, these batteries are expensive, inconvenient, and are subject to depletion.

Accordingly, there is a need in the art for methods and systems, which provide convenient device charging options.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for electric generators.

It is another aspect of the disclosed embodiments to provide a method, system, and apparatus for mobile generators.

It is another aspect of the disclosed embodiments to provide a method, system, and apparatus to facilitate charging devices.

It is another aspect of the disclosed embodiments to provide methods, systems, and apparatuses for a three-dimensional kinetic generator using a gyroscope.

It is another aspect of the disclosed embodiments to provide methods, systems, and apparatuses for a three-dimensional motor/generator using a gyroscope.

It is another aspect of the disclosed embodiments to provide methods, systems, and apparatuses for socket stepper motors.

The aforementioned aspects and other objectives and advantages can now be achieved as described herein. In embodiments disclosed herein, a generator system comprises at least one magnet housed in a gyroscope, a coiled wire formed on at least one support associated with the gyroscope, wherein movement of the coiled wire formed on the at least one support induces an electric current in the coiled wire, and an electrical lead for outputting electric power from the coiled wire.

In another embodiment, a generator system comprises at least one gyroscope, a core wrapped in coils formed inside a central void of the gyroscope, at least one ring with at least one gear attached thereto with at least one pin, connecting the core and the gyroscope such that the at least two gears are driven by the gyroscope, two magnets connected to the gyroscope such that the core wrapped in the coils is within a magnetic field between the two magnets, wherein movement of the spheres in relation to the two magnets induces an electric current in the coils, and an electrical lead for outputting electric power from the coils.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1A depicts a gyroscope-based system for generating energy in accordance with the disclosed embodiments;

FIG. 1B depicts a magnetic core and coil wrapped support member in accordance with the disclosed embodiments;

FIG. 1C depicts a magnetic core and coil wrapped support member in accordance with the disclosed embodiments;

FIG. 2 depicts a gyroscope-based system for generating energy in accordance with another disclosed embodiment;

FIG. 3 depicts a diagram of current inducement in accordance with the disclosed embodiments;

FIG. 4A depicts a ring gear assembly in accordance with the disclosed embodiments;

FIG. 4B depicts a ring gear assembly in accordance with the disclosed embodiments;

FIG. 4C depicts a ring gear assembly in accordance with the disclosed embodiments;

FIG. 4D depicts a ring gear assembly in accordance with the disclosed embodiments;

FIG. 5 depicts a flow chart illustrating a method for generating energy in accordance with the disclosed embodiments; and

FIG. 6 depicts a flow chart illustrating a method for generating energy in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the embodiments disclosed herein, a three-dimensional kinetic generator and/or motor generates electricity by taking advantage of a combination of the force of gravity, an external source of motion, and Faraday's Law.

The embodiments disclosed herein provide systems and methods associated with a three-dimensional generator/motor that generates electricity by taking advantage of a combination of the force of gravity and an external source of motion. In particular, by tilting the embodiments disclosed herein, along their x and/or y axis of motion (as well as a version to produce electricity along the z-axis, as further described herein), the rotational/kinetic energy can be converted to electricity. As such, the embodiments can be used as personal charging devices and/or as a precision socket stepper motor that operates via the everyday motion of the user.

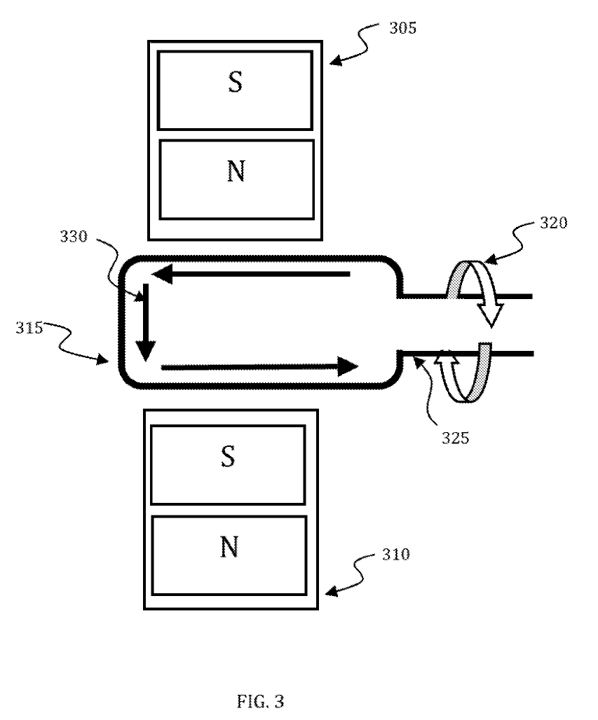

In general, a magnetic field exists between two adjacent magnets 305 and 310 with a coil 315 between them. The magnets 305 and 310 can be arranged with their respective north and south poles facing each other. When the coil 315 rotates as illustrated by arrow 320 a change in the relative magnetic field results, causing a voltage difference between the two ends of the wire 325, which in turn creates a current, as shown by arrow 330, that can be used to power devices. This is illustrated in FIG. 3. For further reference, the embodiments disclosed herein operate according to the principle of induced electro-motive forces (EMFs). The embodiments therefore differ from conventional generators in the method by which mechanical energy is “harvested.”

In one embodiment, the phenomena illustrated in FIG. 3 can be captured in a system comprising a weighted magnetic sphere. The magnetic sphere is downwardly weighted so as to be held in the central void of a gyroscope. The gyroscope can be surrounded by one or more curved tubes wrapped with wire. The wrapped wires form a solenoid, curved solenoid, toroid, and/or partial toroid. Because the magnetic sphere is weighted, no matter the direction in which the outer ring is moved, the inner magnetic sphere will always remain pointed downward. When the outer ring is moved, the magnetic field associated with the magnetic sphere interacts with the coiled tubes, and induces a voltage that causes electrons to flow in the associated wire.

In certain embodiments, the tubes can be configured to surround the outer ring of the gyroscope entirely, so that a voltage will always be fully induced by one set of tubes, while the remaining tubes will at least partially induce a voltage. When the assembly is attached to an object in motion, like an arm, leg, backpack, etc., as the object moves through three-dimensional space, the three-dimensional kinetic generator converts the kinetic energy associated with the motion of the wrapped wire around the magnetic source, into an electric voltage that can be used to power or charge a device.

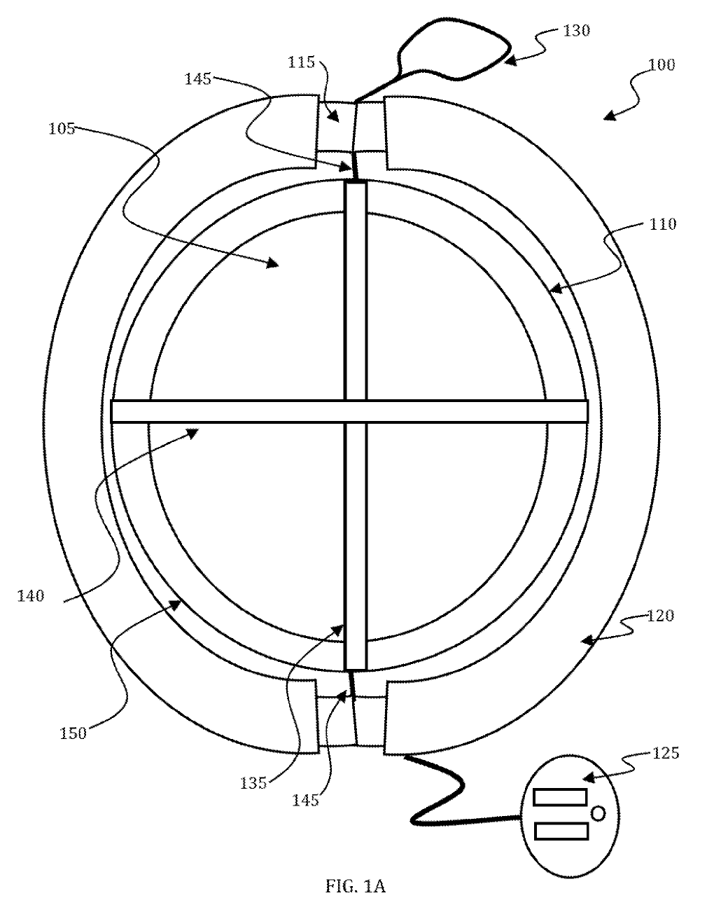

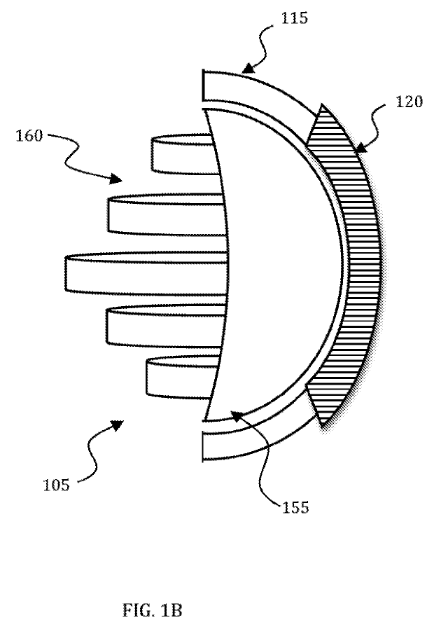

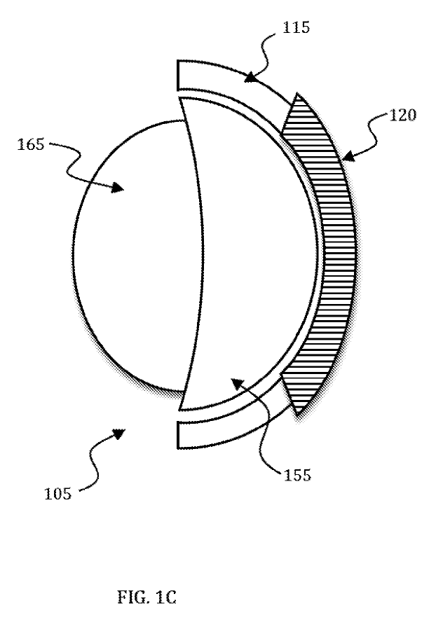

FIG. 1A illustrates an embodiment of a three-dimensional kinetic generator system 100 for portable power generation. The system includes a magnetic source 105. The magnetic source 105 can comprise one or more magnets, forming a magnetic sphere or other desired shape. It should be appreciated that the magnetic source 105 can be spherical in shape in order to ensure an even magnetic field distribution, or may be embodied as other shapes that provide a desired magnetic field, depending on design considerations. Generally, the magnet may be any permanent magnet, including but not limited to, rare earth magnets, neodymium magnets such as neodymium “D62-N52” magnets, and other such magnets. The one or more magnets can be configured such that the magnetic source 105 is downwardly weighted and held in a specific orientation with respect to the gyroscope. The orientation will most commonly be in the voided center of a gyroscope 110, but other orientations are also possible.

Gyroscope 110 can comprise any gyroscopic configuration. In an embodiment, gyroscope 110 comprises a mechanism including a rotor coupled to, or otherwise comprising, the magnetic sphere and configured to spin about one axis, which can be referred to as the spin axis. The rotor/magnetic source 105 can be operably connected to the inner support ring 135, via connectors 145 on the spin axis, which is in turn, operably connected to an outer support ring 140. The support ring system, which connects to the frame 150 of the gyroscope 110, is mounted so as to pivot about an axis in its own plane, determined by the support. The outer support ring 140 has one degree of rotational freedom and the inner support ring 135 is mounted to rotate such that it is always perpendicular to the rotational axis of the outer support ring 140. Similarly, the rotor is configured to spin around an axis, that is always perpendicular to the axis of the inner support ring 135. The rotor thus possesses three degrees of rotational freedom and its axis possesses two. It should be appreciated that, in other embodiments, additional support rings can be included, according to design considerations.

In an embodiment, the center of gravity of the magnetic sphere 105 can be held constant. This may be achieved by affixing the magnetic sphere 105 to the rotor and/or downward weighting the sphere. Thus, the gyroscope 110 is free to turn in any direction about a fixed point, but the magnetic sphere 105 maintains a fixed orientation. It should be understood that the gyroscope 110 may be embodied as any gyroscope provided that the gyroscope is configured to ensure the magnetic sphere's 105 orientation within the gyroscope 110 remains constant. The embodiments are configured to prevent the magnetic source 105 from rotating in concert with the supports and wire windings, which would reduce the induced voltage experienced in the wire winding.

One or more supports 115 can surround the gyroscope 110. The supports 115 can be curved to match the profile of the gyroscope 110 (or can be chosen to have a different shape as necessary to optimize current inducement from the magnetic field) and are connected to the gyroscope 110 such that they are free to move around the gyroscope 110. Alternatively, the supports 115 can be integrated with the gyroscope 110. In the embodiments, the supports 115 are wrapped in whole or in part, in wire 120. The wire wrap or coil 120 forms a solenoidal and/or toroidal type structure around the support 115. The supports 115 may be tubular, solid, or hollow. The supports are preferably formed of a lightweight non-magnetic material.

As the outer supports 115 move, the magnetic field associated with the magnetic sphere 105 induces a voltage in the coiled wire 120 around the supports 115. The wire windings 120 are critical in effectively producing electricity. The energy production is a consequence of Faraday's Law, which explains that a voltage will be generated in wire coil 120 when the magnetic field and/or magnetic flux through the coil change. In a preferred embodiment, multiple support tubes 115 can surround the outer support ring 140 entirely. Thus, one set of tubes will always be fully induced and the remaining tubes will be partially induced. The induced voltage can be used to power or charge the battery of a device.

In an embodiment, a power supply connection 125 can be electrically connected to the wire wrap 120. It should be appreciated that the power supply connection 125 may be embodied as any type of connection that supports the transmission of power such as a power cable, USB, Firewire, a two prong outlet, a three prong outlet, or the like.

The gyroscope 110 can further include a connector 130 that is configured to attach the gyroscope to a person. The connector 130 may be embodied as a clip, carabineer, strap, hook and loop band, etc. When the system 100 is attached to an object in motion (e.g., a user's arm, leg, belt, backpack, etc.) via connector 130, as the object moves through three dimensional space the coil wrap 120 moves around the downward weighted magnetic member producing voltage that can be used to power or charge a device such as a mobile phone, table device, computer, or other such electrically operated device.

FIG. 1B illustrates a detailed view of an embodiment of magnetic source 105 and support 115. As illustrated, the magnetic source 105 can include a cover 155 that encloses one or more magnets 160. In certain embodiments, the magnets can comprise one or more disk magnets. FIG. 10C illustrates that in other embodiments, the magnet can comprise a spherical magnet 165.

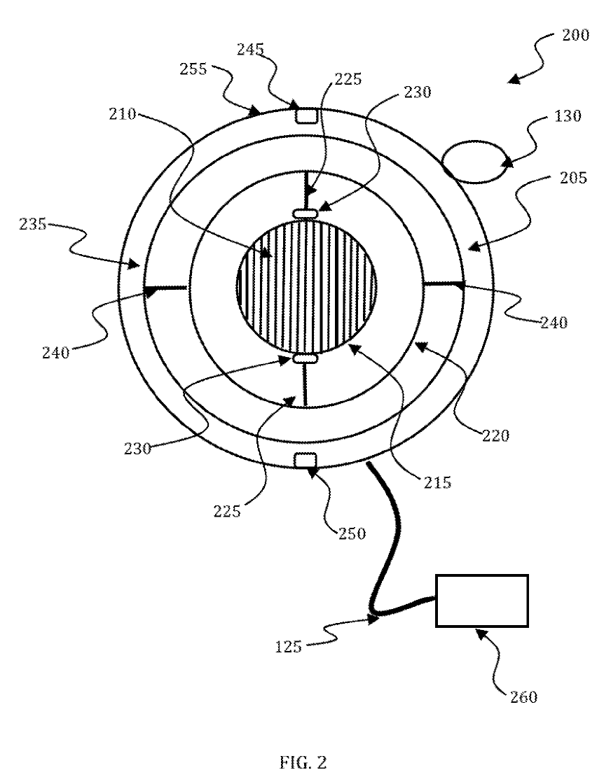

In another embodiment, a three dimensional generator/motor 200 is disclosed, as shown in FIG. 2. The three dimensional generator/motor 200 includes a bottom weighted gyroscope 205. A sphere 215 (or other shape) in the core of the generator 200 is wrapped in coils 210 (e.g., wires forming a solenoid, toroid, etc., that facilitate the flow of electricity and are attached to an electric port 125) that are connected to the bottom-weighted gyroscope 205. A ring 220 with pins 225 that have gears 230 attached thereto, connect the sphere 215 and the gyroscope 205 such that the gears 230 are parallel to the coils 210 so that it is driven by the gyroscope 205.

An outer sphere 235 can also be wrapped in coils and can be attached in the exact same way as the inner sphere with pins 240. Two magnets 245 and 250 are placed at 45-degree angles (or other angels in other embodiments) from the pins on an outer ring of the gyroscope, or the outer sphere 235. The magnets 245 and 250 are situated such that the opposite polarity of the respective magnets is facing each other. The system 200 can further be enclosed in a case 255 with a connector 130.

The gyroscope is downwardly weighted. During use, the weight of the gyroscope causes the gyroscope to quickly reach equilibrium and thus point straight down, even when the system 200 is displaced at a random angle. Therefore, no matter the orientation of the gyroscope, or what direction it is moved, it will remain pointed downwards.

When the gyroscope rotates, the solenoid (i.e., coils) between the two magnets 245 and 250 experiences a change in the magnetic field between the two magnets 245 and 250. As the outer sphere 235 and/or gyroscope 205 moves (i.e., via kinetic motion), the magnetic field interacts with the coils on the outer sphere 235 or coils 210 on sphere 215 associated with gyroscope 205. As a result, electrons in the coiled wire move, producing energy embodied as electricity. Since the sphere 215 and/or spheres 220 and sphere 235 can be partially or entirely covered with coils, and rotate between the magnets 245 and 250, the kinetic energy associated with that movement is converted to electric energy flowing through the coils, which allows the system 200 to be used as a generator or a motor. As with the other embodiments, an electrical port 125 connected to the wires and/or coils can be provided on, or from, the surface of case 255 so that the system can be used to power or charge an electrically powered device 260.

As in the embodiment illustrated in FIG. 1A, the embodiment provided in FIG. 2 provides a 3-D gyroscope where the core of the gyroscope is a sphere that is weighted downwards so its orientation does not change regardless of how the gyroscope is displaced. Both embodiments generate electrical power via rotation when the gyroscope is displaced due to kinetic motion of the user.

The embodiment in FIG. 2 differs from that of FIG. 1A in that the sphere 215 is wrapped in coils 210 that rotate between magnets 245 and 250, which can be placed at a 45 degree angle from the pins. In addition, the present embodiments include a ring with pins that have gears attached thereto that connect the sphere and the gyroscope that are parallel to the coil so that it is driven by gyroscope. In addition, the embodiments include a gear system, and a second outer sphere that can be attached, and works the same way as the inner sphere. These differences make the embodiments illustrated in FIG. 2 additionally useful as a precision socket stepper motor.

The embodiments take advantage of the motion of a user by converting the force of gravity into rotational motion. This is done using a gyroscope and gear shafts. A gyroscope is preferable because it is inexpensive, consolidates necessary parts, and reduces the likelihood of more than one generators (as is common in the prior art) not moving when tilted at angles around 45 degrees.

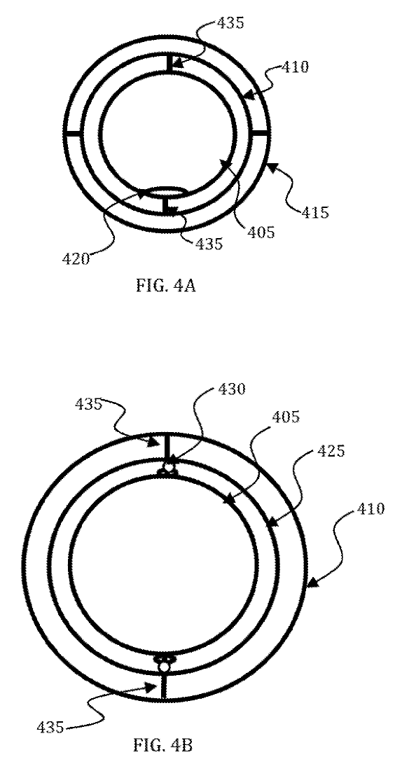

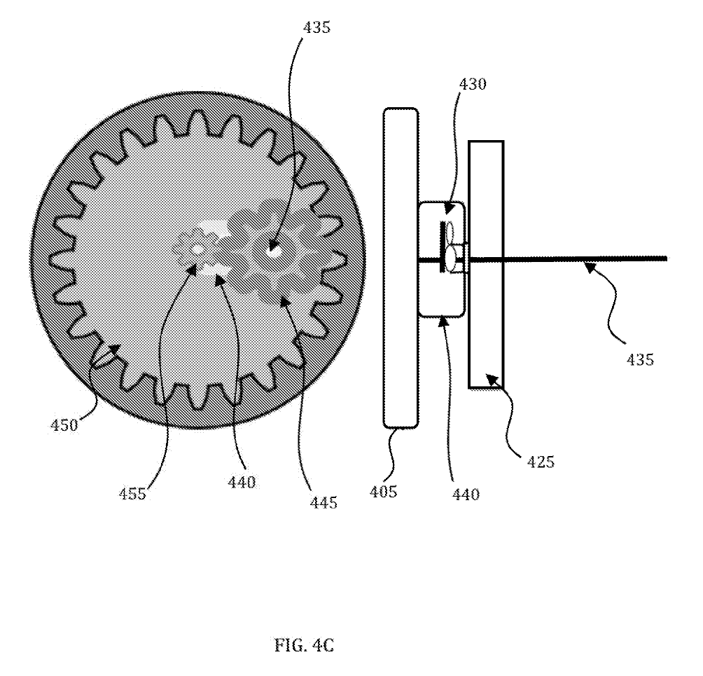

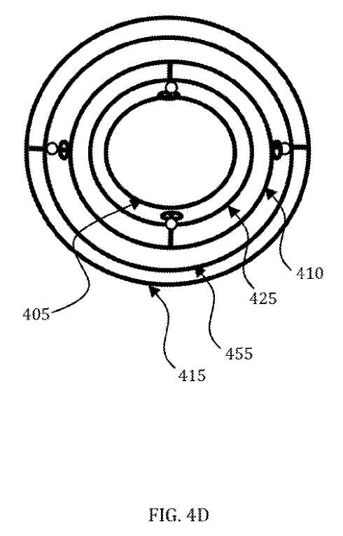

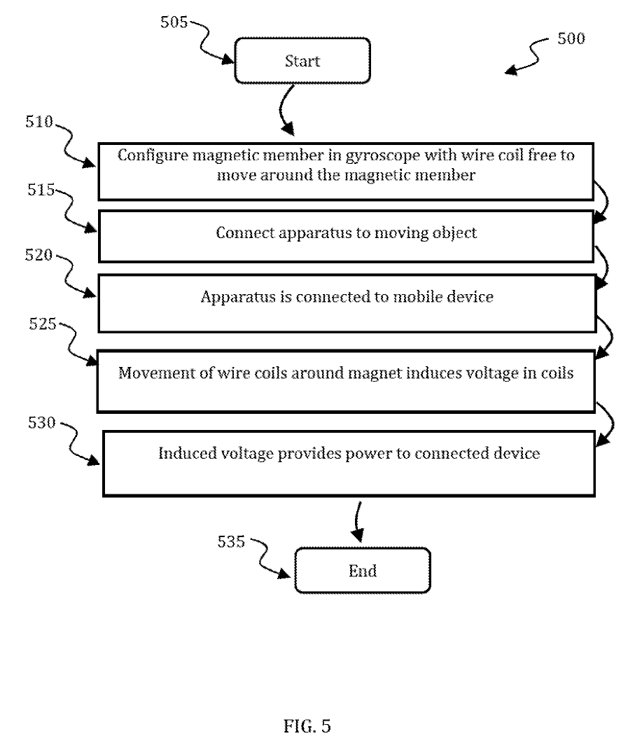

FIGS. 4A and 4B illustrate a gyroscope with a weight 420 attached to a center ring 405. It should be appreciated that the gyroscope illustrated in FIGS. 4A and 4B could be used in any of the embodiment's disclosed herein. Furthermore, throughout this description the use of the term ring can refer to a ring or a sphere according to design considerations.

In FIG. 4A, a standard gyroscope is illustrated with a center ring 405, middle ring 410 connected to the center ring 405, and external housing 415.

FIG. 4B further details the inclusion of a gear shaft in accordance with the disclosed embodiment. In FIG. 4B, an additional ring 425 is arranged between the middle ring 410 and center ring 405. The additional ring 425 moves on the same axis as the center ring 405, in relation to the middle ring 410. The additional ring 425 can be driven by a gear shaft 430 connected to the center ring 405 which in turn, is driven by gravity due to the weight attached to the center ring 405. In certain embodiments, the center ring 405 can be embodied as a coil wrapped sphere.

FIG. 4C illustrates the gearing 430 connecting the center ring 405 and additional ring 425. The middle ring 425 can be attached to pins 435 that go through both the additional ring 425 and center ring 405. The pins allow the rings to rotate there about. Attached to the pins 435, is a rigid platform 440 where the planetary gear 445 is attached. When the center ring gear 450 rotates due to gravity, the planetary gear 445 turns, which in turn spins the small gear 455. This reduction in gear size increases the small gear's 455 speed in relation to the speed of the center ring gear 450. In certain embodiments, the gears can be chained to further increase speed. The middle ring 425 can be connected similarly to the center ring 405, as the weight in the center ring 405 applies to the middle ring 425 along its axis.

In certain embodiments, a gear train can further include five gears which results in an overall gear ratio of 1:81. The gears can be composed of ABS plastic or other such material that is lightweight and durable. It should be understood that different numbers of gears, gear ratios, and gear materials may alternatively be used.

FIG. 4D illustrates yet another embodiment wherein the middle ring 410 can be connected to outer ring 455 in the same manner as described above with respect to the center ring 405 and additional ring 425.

It should be understood that, while the additional ring 425 and outer ring 455 (and all other rings in certain embodiments) have been described as “rings,” they can be embodied as spheres. In the embodiments disclosed herein, both the additional ring 425, embodied as a sphere, and outer ring 455, embodied as a sphere can be wrapped in wire coils arranged parallel to the pins they reside on. As illustrated in FIG. 2, magnets can then be configured at 45 degree angles from both pins, and are arranged with their respective north and south poles facing each other. As the system is tilted, the coiled spheres rotate quickly and induce electricity flow.

In another embodiment a rack and pinion gear can be added to the system illustrated in FIG. 2. By adding a rack and pinion gear within the center ring 405, energy can also be transferred in the z direction. In such an embodiment, the “rack gear” can be weighted and free moving, thus spinning a “pinion gear” which in turn rotates a third sphere with its coils perpendicular to the magnetic field it resides within.

In another embodiment, electricity can be applied to the previously described system (for example, with a connecting cable) such that the system can be used as a motor. In such an embodiment, the optional rack and pinion addition is excluded. In addition, the gear shaft can be inverted in order to create the precision movement. Finally, the weight in the motor is also removed in such an embodiment.

In certain embodiments, with the system can induce a voltage of approximately 3.5V. This is sufficient for applications on small portable electronics such as: flashlights, speakers, mobile phones, handled devices, and similar products. It should be appreciated that by modifying certain parameters the induced voltage can be increased or decreased.

It should be appreciated that in certain embodiments, the number of coils can be increased (i.e., the coil turn density is increased), as well as the gear ratio and/or number of gears, which can improve performance. Iron can be used as the material for the weight 420 given that it is relatively inexpensive and has a relatively high density of 7.83 g/cm3, however other materials can also be used.

FIG. 5 illustrates a flow chart depicting steps of a method 500 for generating energy using the systems illustrated in FIG. 1A. The method beings at step 505. At step 510, a downwardly weighted magnetic member is housed in a gyroscope. Support structures can be wrapped in wire. The support structure and coiled wire are free to move around the magnetic member housed in the gyroscope. At step 515, the gyroscope is attached to a moving object and at step 520 the coiled wire is electrically connected to a device that requires power. At step 525, movement of the support structure and coils around the magnetic member induces a current in the coiled wire. The resulting voltage is then used to power the connected device as illustrated at step 530. The method ends at step 535.

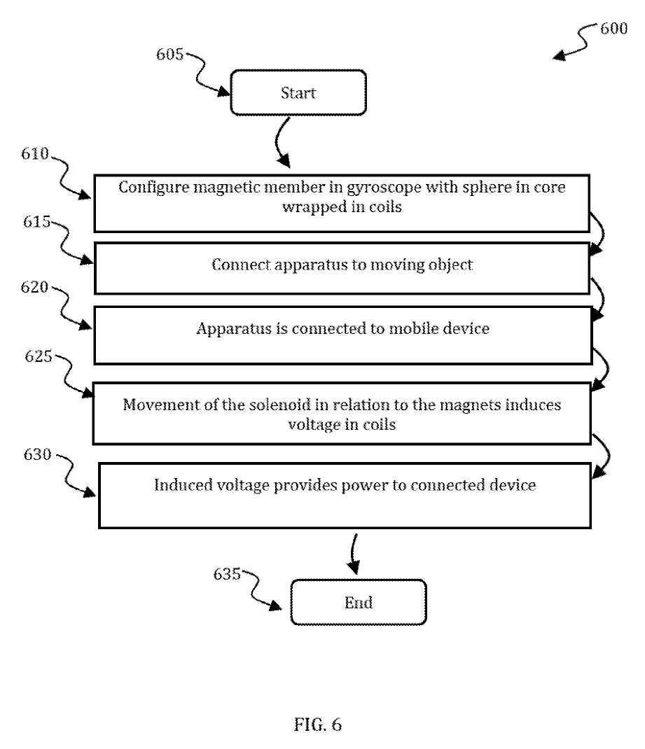

FIG. 6 illustrates a flow chart depicting steps in a method for generating energy according to the systems disclosed with respect to FIG. 2. The method beings at step 605. At step 610, a downwardly weighted magnetic member is housed in a gyroscope. A sphere in the core of the apparatus is wrapped in coils that are connected to the bottom weighted gyroscope. A ring with pins that have gears attached to it connect the sphere and the gyroscope that are parallel to the coil so that it is driven by the gyroscope. An outer sphere can also be wrapped in coils and can be attached the exact same way as the inner sphere. Two magnets are placed at 45-degree angles (or other angels in other embodiments) from both pins that are facing each other. At step 615, the device is connected to a moving object. At step 620, the apparatus is connected to a mobile device. At step 625, movement of the support structure around the magnetic member induces a current in the solenoid. The resulting voltage is then used to power the connected device as illustrated at step 630. The method ends at step 635.

Thus, in certain embodiments, a palm-sized generator is disclosed. In certain embodiment, the generator or generators can be configured into a chip as an array of generators capable of powering any number of devices. In addition, in certain embodiments, the product can be used as a precision socket motor and applied in multiple applications including those in the medical industry, robotics, and other specialized machinery. In an embodiment, a power supply connection can be electrically connected to the solenoid. It should be appreciated that the power supply connection may be embodied as any type of connection that supports the transmission of power such as a power cable, USB, Firewire, a two prong outlet, a three prong outlet, or the like.

Accordingly, the embodiments disclosed herein describe a three-dimensional kinetic generator that generates electricity through the combination of gravity, an external source of motion, and Faraday's Law. A downwardly weighted magnetic sphere is held in the center of a gyroscope. The gyroscope is surrounded by curved tubes wrapped with wire coils. Because the magnetic sphere is downwardly weighted, no matter what direction the outer ring is moved, the inner magnetic sphere will always remain pointed downward. As the outer ring is moved, the magnetic field interacting with the coiled tubes moves electrons in the wire producing energy. Because the tubes surround the outer ring entirely, one set of tubes will always be fully induced and the remaining tubes will be partially induced (i.e., a voltage will be induced). When attached to an object in motion like an arm or a leg, as the object moves through three-dimensional space, the three-dimensional kinetic generator produces electricity.

The embodiments disclosed herein can also comprise a gyroscope with a weight attached to it. Gravity causes the gyroscope to find equilibrium with the weight pointed down, even when displaced by an arbitrary angle. A series of gears can be incorporated to translate the gyroscope's rotation to a solenoid placed between two magnets. In certain embodiments, the magnets can comprise powerful neodymium cylindrical bar magnets, although other magnets may also be used.

Various parameters associated with this embodiment, including but not limited to gear ratios, magnetic field strength, turn density of the solenoid, separation distance between the two magnets, and the mass of the weight can be modified to achieve a desired result. In certain embodiments, the parameters can be adjusted to produce a sufficient EMF to charge various hand-held items including, but not limited to, cell phones, MP3 players, flashlights, and speakers. In certain embodiments, the system can include a pendulum attached to a gear train (which can be both regular and/or compound gears), which are connected to a solenoid spinning in a magnetic field. In accordance with the embodiments disclosed herein, in a smallest form the system can be the same approximate size as the smallest possible motor, in turn allowing for multiple axes of motion on a much smaller scale and lower price than other prior art options.

Based on the foregoing, it can be appreciated that a number of embodiments, preferred and alternative, are disclosed herein. For example in one embodiment, a generator system comprises at least one gyroscope, a core wrapped in coils formed inside a central void of the gyroscope, at least one ring with at least one gear attached thereto with at least one pin, connecting the core and the gyroscope such that the at least two gears are driven by the gyroscope, two magnets connected to the gyroscope such that the core wrapped in the coils is within a magnetic field between the two magnets, wherein movement of the spheres in relation to the two magnets induces an electric current in the coils, and an electrical lead for outputting electric power from the coils. In an embodiment, the core further comprises a sphere.

In an embodiment, the system further comprises an outer sphere wrapped in coils connected to the gyroscope. In an embodiment, the outer sphere and the gyroscope are parallel to the coil so that it is driven by the gyroscope.

In another embodiment, the two magnets are configured so that their opposing poles face each other. In an embodiment, the two magnets are configured at 45 degree angels from the pins.

In another embodiment, the system further comprises a weight in the core member that secures the core's orientation with respect to the gyroscope. In another embodiment, a connection member is configured to connect the system to a moving object.

In another embodiment, the two magnets comprise at least one of a plurality of magnets, a rare earth magnet, and a neodymium magnet.

In another embodiment, a generator system comprises at least one magnet housed in a gyroscope, a coiled wire formed on at least one support associated with the gyroscope, wherein movement of the coiled wire formed on the at least one support induces an electric current in the coiled wire, and an electrical lead for outputting electric power from the coiled wire.

In an embodiment, the magnet comprises at least one of a plurality of magnets, a rare earth magnet, and a neodymium magnet. In an embodiment, the at least one magnet is configured to form a weighted sphere arranged in the center of the gyroscope.

In an embodiment, the at least one support further comprises a plurality of supports. The plurality of supports further comprise independently rotatable rings.

In another embodiment, the system further comprises an outer ring associated with the gyroscope, wherein the plurality of supports surrounds the outer ring entirely. In an embodiment, the gyroscope is configured to ensure an orientation of the at least one magnet remains constant.

In yet another embodiment, an apparatus comprises at least one gyroscope, a sphere wrapped in coils connected to the gyroscope, a ring associated with the gyroscope, at least two gears attached to the ring with at least one pin, the pin thereby connecting the sphere and the gyroscope such that the at least two gears are driven by the gyroscope, an outer sphere wrapped in coils connected to the gyroscope, and two magnets connected to the outer sphere wherein movement of the spheres in relation to the two magnets induces an electric voltage.

In an embodiment, the two magnets are configured so that their opposing poles are facing each other. In an embodiment, the two magnets are configured at 45 degree angels from the at least one pin. In an embodiment, the system further comprises a housing configured to enclose the gyroscope therein and a connection member configured to connect the housing to a moving object.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A generator system comprising:
at least one gyroscope;
a core wrapped in coils formed inside a central void of said gyroscope;
at least one ring with at least one gear attached thereto with at least one pin, connecting said core and said gyroscope such that the at least one gear is driven by the gyroscope;
two magnets connected to said gyroscope such that said core wrapped in said coils is within a magnetic field between said two magnets, wherein movement of the spheres in relation to the two magnets induces an electric current in said coils; and
an electrical lead for outputting electric power from said coils.

2. The system of claim 1 wherein said core further comprises a sphere.

3. The system of claim 1 further comprising:
an outer sphere wrapped in coils connected to the gyroscope.

4. The system of claim 3 wherein said outer sphere and said gyroscope are parallel to said coil so that it is driven by said gyroscope.

5. The system of claim 1 wherein said two magnets are configured so that their opposing poles face each other.

6. The system of claim 1 wherein said two magnets are configured at 45-degree angels from said pins.

7. The system of claim 1 further comprising a weight associated with said core member configured to secure said core member's orientation with respect to said gyroscope.

8. The system of claim 1 further comprising a connection member configured to connect said system to a moving object.

9. The system of claim 1 wherein each of said two magnets comprise at least one of:
a plurality of magnets;
a rare earth magnet; and
a neodymium magnet.

10. A generator system comprising:
at least one magnet housed in a gyroscope;
a coiled wire formed on at least one support associated with said gyroscope, wherein movement of the coiled wire formed on the at least one support induces an electric current in said coiled wire; and
an electrical lead for outputting electric power from said coiled wire.

11. The system of claim 10 wherein said magnet comprises at least one of:
a plurality of magnets;
a rare earth magnet; and
a neodymium magnet.

12. The system of claim 10 wherein said at least one magnet is configured to form a weighted sphere arranged in the center of said gyroscope.

13. The system of claim 10 wherein said at least one support further comprises a plurality of supports.

14. The system of claim 13 wherein said plurality of supports further comprise independently rotatable rings.

15. The system of claim 14 further comprising an outer ring associated with said gyroscope, wherein said plurality of supports surround said outer ring entirely.

16. The system of claim 10 wherein said gyroscope is configured to ensure an orientation of said at least one magnet remains constant.

17. An apparatus comprising:
at least one gyroscope;
a sphere wrapped in coils connected to said gyroscope;
a ring associated with said gyroscope;
at least two gears attached to said ring with at least one pin, said pin thereby connecting said sphere and said gyroscope such that said at least two gears are driven by said gyroscope;
an outer sphere wrapped in coils connected to said gyroscope; and
two magnets connected to said outer sphere wherein movement of said spheres in relation to said two magnets induces an electric voltage.

18. The apparatus of claim 17 wherein said two magnets are configured so that their opposing poles are facing each other.

19. The apparatus of claim 17 wherein said two magnets are configured at 45 degree angels from said at least one pin.

20. The system of claim 1 further comprising:
a housing configured to enclose said gyroscope therein; and
a connection member configured to connect said housing to a moving object.
